(19) United States
(12) Patent Application Publication
(10) Pub. No.: US 2018/0315329 A1
(43) Pub. Date: Nov. 1, 2018

(54) AUGMENTED REALITY LEARNING SYSTEM AND METHOD USING MOTION CAPTURED VIRTUAL HANDS

(71) Applicant: Vidoni, Inc., Brooklyn, NY (US)

(72) Inventors: Kenneth Charles D'AMATO, Sound Beach, NY (US); Michal SUCH, Wroclaw (PL)

(21) Appl. No.: 15/957,247

(22) Filed: Apr. 19, 2018

Related U.S. Application Data
(60) Provisional application No. 62/487,317, filed on Apr. 19, 2017.

(51) Int. Cl. G09B 5/06; G09B 5/02; G09B 15/00; G09B 19/00

(52) U.S. Cl. CPC G09B 5/06; G09B 5/02; G06N 3/08; G09B 19/003; G09B 15/00

(57) ABSTRACT

The present disclosure is directed towards an extended reality (XR) learning system that provides users with hands-on visual guidance from an instructor or expert using an XR device. The XR learning system includes a motion capture system to record an expert's hands performing a task and a processor to generate a (bone-by-bone) representation of the expert's hands from the recording. The processor can then generate a model of the expert's hands based on the representation. This model can be modified and calibrated to a particular user. Once the user requests content, the processor can transfer the recording to the user's XR system, which can then display the model of the expert's hands overlaid on the user's hands to help visually guide the user to perform the task.

### CROSS-REFERENCE TO RELATED APPLICATION(S)

This application claims the priority benefit, under 35 U.S.C. § 119(e), of U.S. Application No. 62/487,317, which was filed on Apr. 19, 2017, is entitled “AUGMENTED REALITY LEARNING SYSTEM WITH MOTION CAPTURED INSTRUCTOR VIRTUAL HANDS THAT A STUDENT SEES THROUGH GOGGLES OR HEADSET OR AS VIDEO OVERLAID ON STUDENT'S HANDS AND WORKING SPACE IN REAL TIME ,” and is incorporated herein by reference in its entirety.

### BACKGROUND

The traditional process of learning a new skill relies upon instructors providing students with hands-on visual guidance and repetition in a classroom. However, for many people, attending classes is not practical due to insufficient time, money, flexibility, and limited access to quality teachers. As a result, it is common to learn new skills by using printed materials or video recordings. The use of such conventional learning materials can ultimately lead to proficiency in a particular skill while providing a cost-effective and convenient alternative to instructional classes. However, the process of learning a new skill in this manner can be slower and less effective due to the lack of guidance traditionally provided by an instructor.

### SUMMARY

Embodiments of the present technology includes methods and systems for teaching a user to perform a manual task with an extended reality (XR) device. An example method includes recording a series of images of an expert's (instructor's) hand, fingers, arm, leg, foot, toes, and/or other body part with a camera while the expert's hand is performing the manual task. A deep-learning network (DLN), such as an artificial neural network (ANN), implemented by a processor operably coupled to the camera, generates a representation of the expert's hand based on the series of images of the expert's hand. For example, the representation generated by the DLN may include probabilities about the placement of the joints or other features of the expert's hand. This representation is used to generate a model of the expert's hand. The model may include reconstruction information, like skin color, body tissue (texture), etc., for making 3D animation more realistic. An XR device operably coupled to the processor renders the model of the expert's hand overlaid on a user's hand while the user is performing the manual task so as to guide the user in performing the manual task.

In some cases, recording the series of images of the expert's hand comprises imaging an instrument manipulated by the expert's hand while performing the manual task. The instrument may be a musical instrument, in which case the manual task comprises playing the musical instrument. In these cases, rendering the model of the expert's hand comprises playing an audio recording of the musical instrument played by the expert synchronized with the rendering the model of the expert's hand playing the musical instrument. Likewise, a microphone or other device may record music played by the expert on the musical instrument while the camera records the series of images of the expert's hand playing the musical instrument. In other cases, the instrument is a hand tool and the manual task comprises installing a heating, ventilation, and air conditioning (HVAC) system component, a piece of plumbing, or a piece of electrical equipment. And in yet other cases, the instrument is a piece of sporting equipment (e.g., a golf club, tennis racket, or baseball bat) and the manual task comprises playing a sport.

Recording the series of images of the expert's hand comprises may include acquiring at least one calibration image of the expert's hand and/or at least one image of a fiducial marker associated with the manual task. Recording the series of images of the expert's hand may include acquiring the series of images at a first frame rate, in which case rendering the model of the expert's hand may include rendering the model of the expert's hand at a second frame rate different than the first frame rate (i.e., the second frame rate may be faster or slower than the first frame rate).

If desired, the camera may provide the series of images to the DLN in real time. This enables the processor to generate the model of the expert's hand and the XR device to render the model of the expert's hand in real time.

In generating the representation of the expert's hand, the DLN may output a bone-by-bone representation of the expert's hand. This bone-by-bone representation provides distal phalanges and distal inter-phalangeal movement of the expert's hand. The DLN may also output translational and rotational information of the expert's hand in a space of at least two dimensions. In generating the model of the expert's hand, the processor may adapt the model of the expert's hand to the user based on a size of the user's hand, a shape of the user's hand, a location of the user's hand, or a combination thereof.

Rendering the model of the expert's hand may be performed by distributing rendering processes across a plurality of processors. These processors may include a first processor operably disposed in a server and a second processor operably disposed in the XR device. The processor may render the model of the expert's hand by aligning the model of the expert's hand to the user's hand, a fiducial mark, an instrument manipulated by the user while performing the manual task, or a combination thereof. They may highlight a feature on an instrument (e.g., a piano key or guitar string) while the user is manipulating the instrument to perform the manual task. And they may render the model of the expert's hand at a variable speed.

An example system for teaching a user to perform a manual task includes an XR device operably coupled to at least one processor. In operation, the processor generates a representation of an expert's hand based on a series of images of the expert's hand performing the manual task with a deep-learning network (DLN). It also generates a model of the expert's hand based on the representation of the expert's hand. And the XR device renders the model of the expert's hand overlaid on the user's hand while the user is performing the manual task so as to guide the user in performing the manual task.

All combinations of the foregoing concepts and additional concepts discussed in greater detail below (provided such concepts are not mutually inconsistent) are part of the inventive subject matter disclosed herein. In particular, all combinations of claimed subject matter appearing at the end of this disclosure are part of the inventive subject matter disclosed herein. The terminology used herein that also may appear in any disclosure incorporated by reference should be accorded a meaning most consistent with the particular concepts disclosed herein.

### BRIEF DESCRIPTION OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar elements).

FIG. 1 shows exemplary applications of the XR learning system including teaching a user to play a musical instrument, installing a mechanical or electrical component, or playing a sport.

FIG. 2A is a block diagram of an exemplary XR learning system that includes a motion capture system to record an expert's hands, a processor to generate models from the recordings, and an XR device to display the recording of the expert's hands.

FIG. 2B shows an exemplary motion capture system from FIG. 2A to record an expert performing a manual task.

FIG. 2C show an exemplary XR device from FIG. 2A to display a recording of an expert's hands while a user is performing a manual task.

FIG. 2D shows a flow chart of the data pathways and types of data shared between the motion capture system, the processor, and the XR system.

FIG. 3 is a flow chart that illustrates a method of using an XR learning system to display a rendered model of an expert's hands performing a task on a user's XR device using a recording of the expert's hands.

FIG. 4A is an image showing an exemplary recording of an expert's hands with annotations showing identification of the expert's hands.

FIG. 4B is an image showing an example of an expert's hands playing a guitar. Fiducial markers used to calibrate the positions of the expert's hands relative to the guitar are also shown.

FIG. 5A is an image showing a bone-by-bone representation of an expert's hands, including the distal phalanges and interphalangeal joints.

FIG. 5B is a flow chart that illustrates a method of generating a representation of an expert's hands based on the recording of an expert's hands.

FIG. 6A is a flow chart that illustrates a method of generating a model of the expert's hands based on a generated representation of the expert's hands.

FIG. 6B is an illustration that shows the processes applied to the model of the expert's hands for adaptation to the user's hands.

FIG. 7A illustrates a system architecture for distributed rendering of a hand model.

FIG. 7B illustrates distribution of rendering processes between an XR device and a remote processor (e.g., a cloud-based server).

### DETAILED DESCRIPTION

The present disclosure is directed towards an extended reality (XR) learning system that provides users with hands-on visual guidance traditionally provided by an expert using an XR device. As understood by those of skill in the art, XR refers to real-and-virtual combined environments and human-machine interactions generated by computer technology and wearables. It includes augmented reality (AR), augmented virtuality (AV), virtual reality (VR), and the areas interpolated among them.

The XR learning system provides the ability to both record and display an expert's hands while the expert performs a particular task. The task can include playing a musical instrument, assembling a mechanical or electrical component for a heating, ventilation, and air conditioning (HVAC) system using a hand tool, or playing a sport. The use of XR can thus provide users a more interactive and engaging learning experience similar to attending a class while still retaining the flexibility and cost savings associated with conventional self-teaching materials.

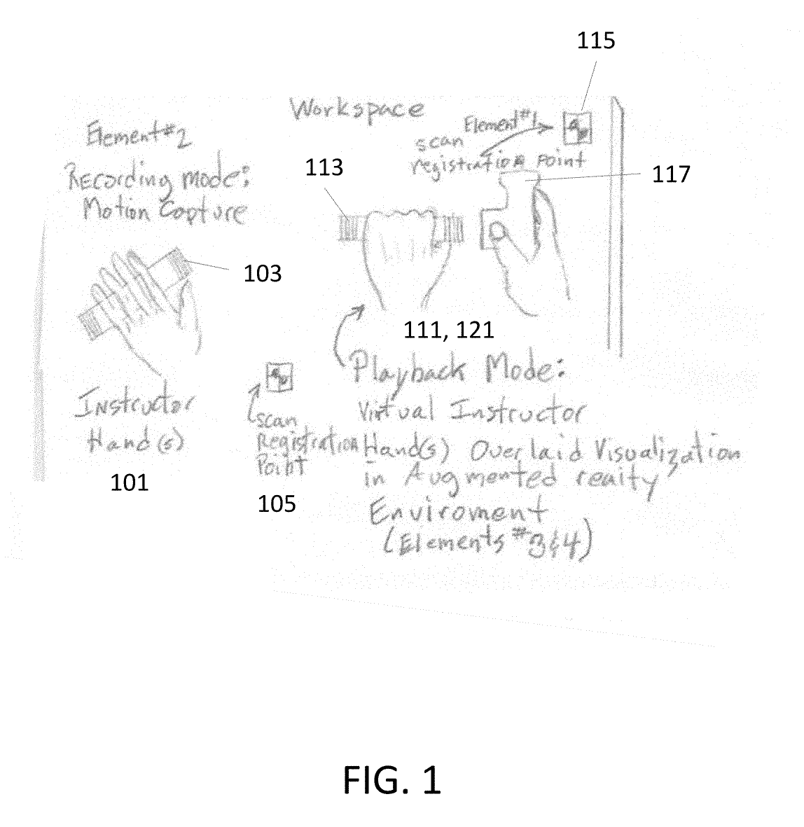

FIG. 1 gives an overview of how the XR learning system works. To start, the XR learning system acquires video imagery of an instructor's hand 101 performing a task, such as manipulating a section of threaded pipe 103 as shown at left in FIG. 1. The XR learning system may also image a scan registration point 105 or other visual reference, including the pipe 103 or another recognizable feature in the video imagery. This scan registration point 105 can be affixed to a work surface or other static object or can be affixed to the instructor's hand (e.g., on a glove worn by the instructor) or to an object (e.g., the pipe 103 or a wrench) being manipulated by the instructor.

As shown at right in FIG. 1, the XR learning system projects a model 121 of the instructor's hand 101 overlaid on a student's hand 111. The XR learning system may project this model in real-time (i.e., as it acquires the video imagery of the instructor's hand 101) or from a recording of the instructor's hand 103. It may align the model 121 to the student's hand 111 using images of the student's hand 111, images of a section of threaded pipe 113 manipulated by the student, and/or another scan registration point 115. The model 121 moves to demonstrate how the student's hand 111 should move, e.g., clockwise to couple the threaded pipe 113 to an elbow fitting 117. By following the model 121, the student learns the skill or how to complete the task at hand.

### AR Learning System Hardware

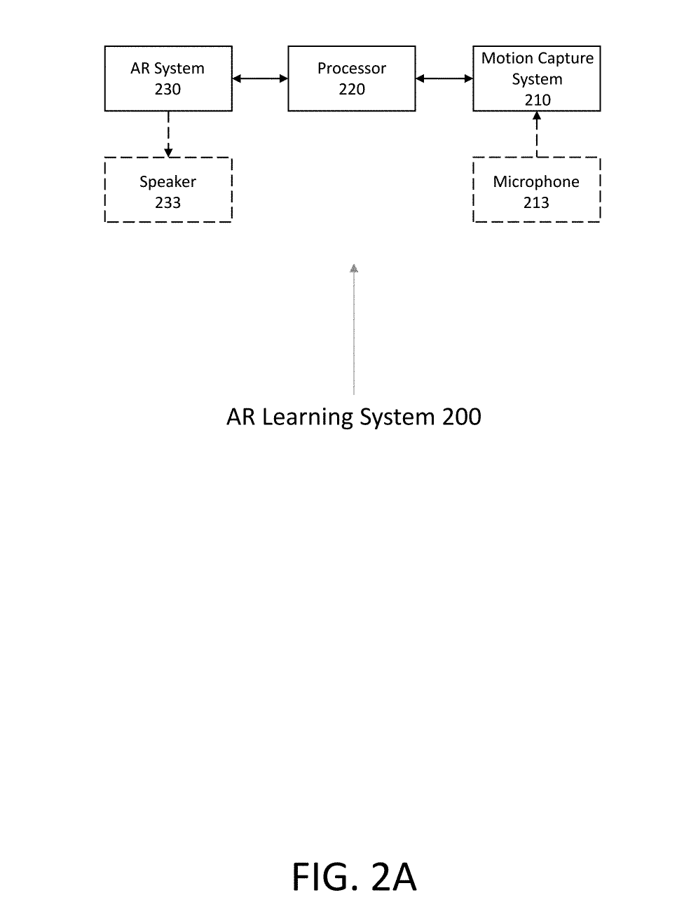

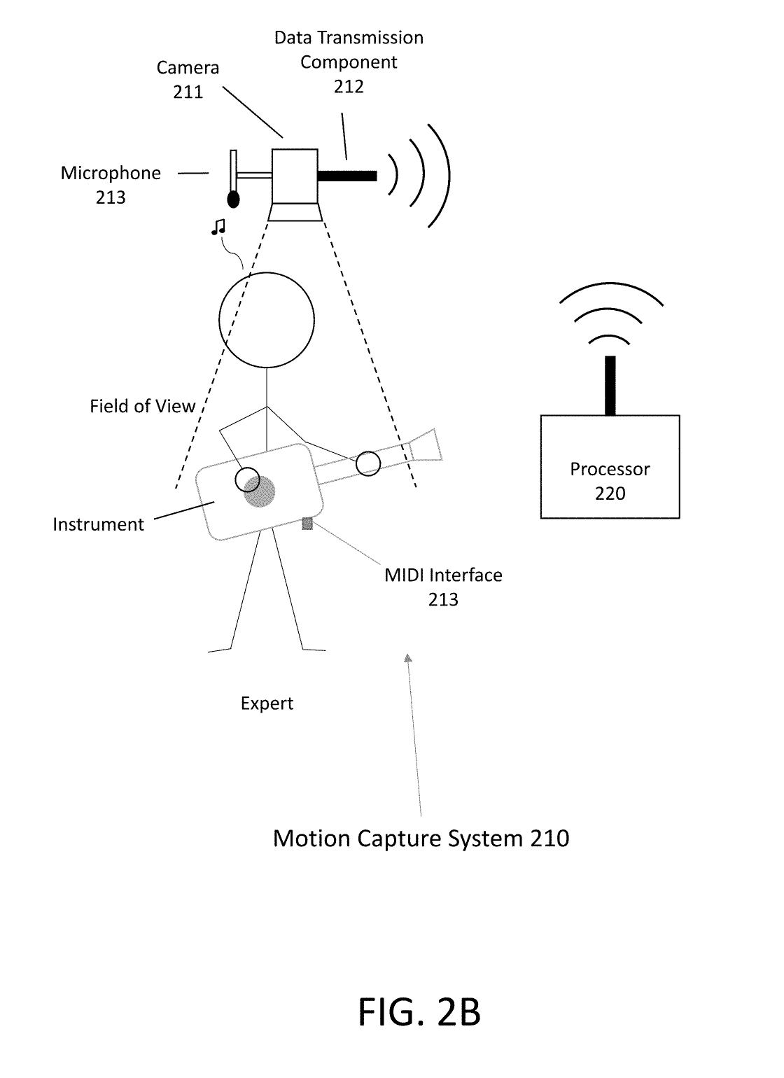

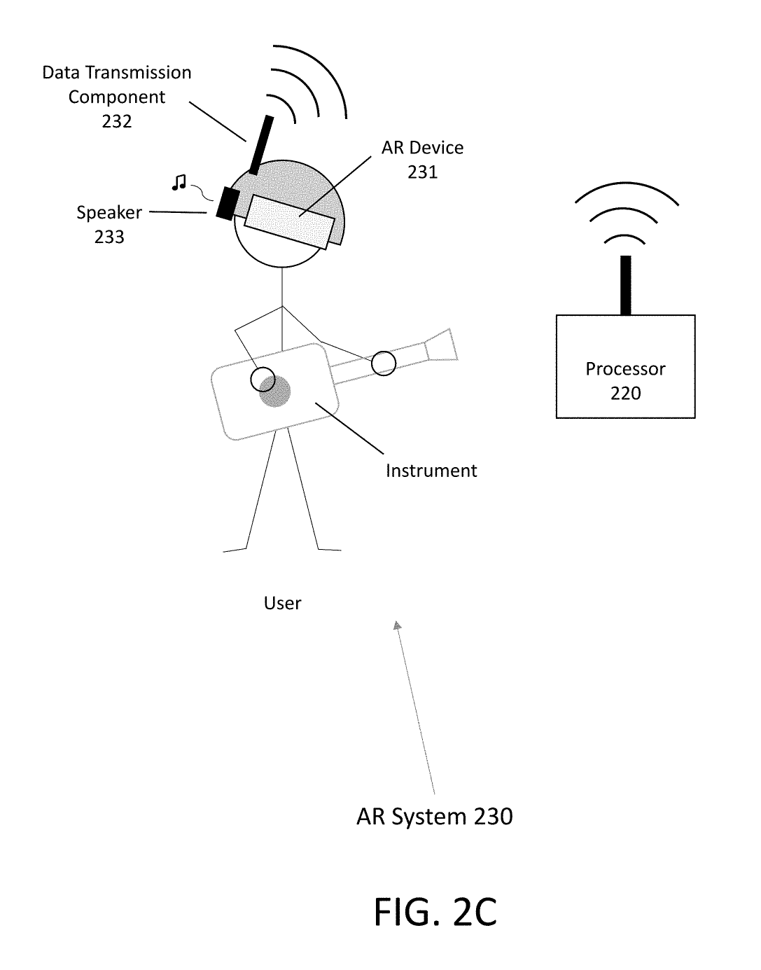

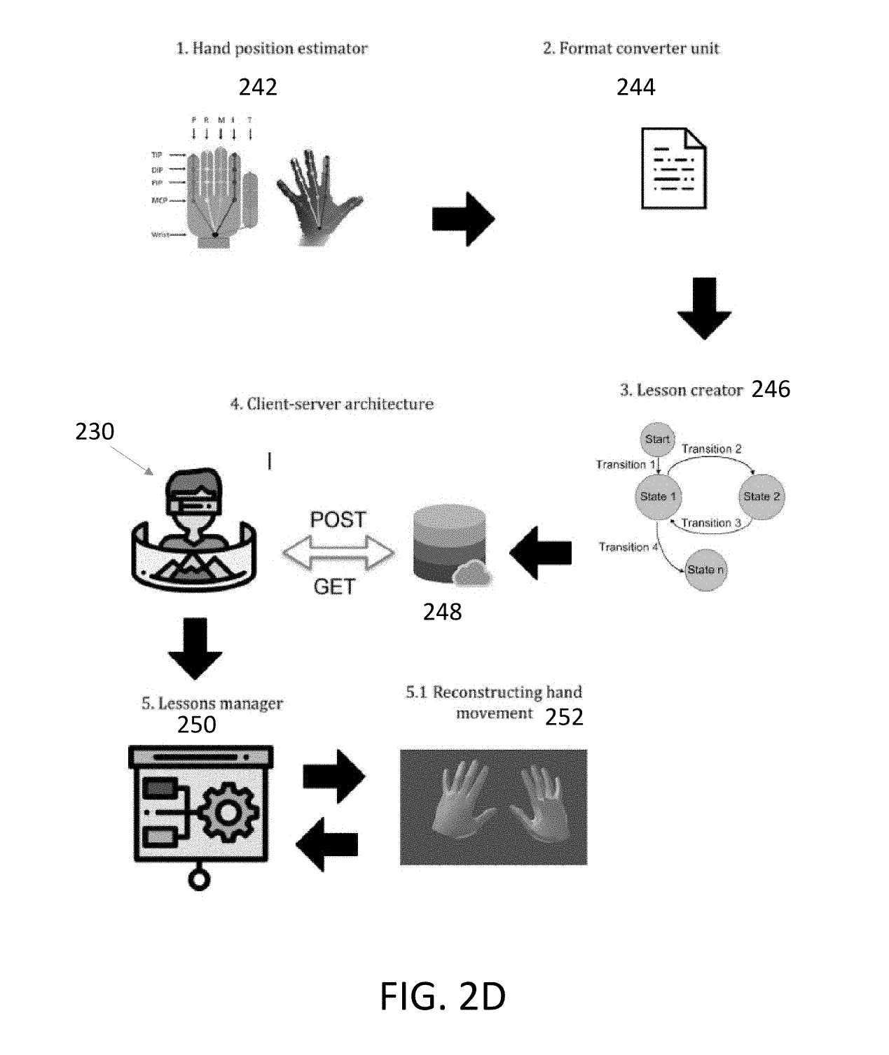

An exemplary XR learning system 200 is shown in FIG. 2A. This system 200 includes subsystems to facilitate content generation by an expert and display of content for a user. The XR learning system 200 can include a motion capture system 210 to record an expert's hands performing a task. A processor 220 coupled to the motion capture system 210 can then receive and process the recording to produce a (bone-by-bone) representation of the expert's hands performing the task. Based on the generated representation, the processor 220 can then generate a 3D model of the expert's hands. This 3D model can be modified and calibrated to a particular user. Once the user requests content, the processor 220 can transfer the recording to the user's XR system 230, which can then display a 3D model of the expert's hands overlaid on the user's hands to help visually guide the user to perform the task.

### Motion Capture System

A more detailed illustration of the motion capture system 210 is shown in FIG. 2B. The motion capture system 210 includes a camera 211 to record video of an expert's hands. The camera 211 may be positioned in any location proximate to the expert so long as the expert's hands and the instrument(s) used to perform the task, e.g., a musical instrument, a tool, sports equipment, etc., are within the field of view of the camera 211 and the expert's hands are not obscured. For example, if an expert is playing a guitar, the camera 211 can be placed above the expert or looking down from the expert's head to view the guitar strings and the expert's hands.

The camera 211 be any type of video recording device capable of imaging a person's hands with sufficient resolution to distinguish individual fingers including a RGB camera, an IR camera, or a millimeter wave scanner. Different tasks may warrant the use of gloves to cover an expert's hands, e.g., welding, gardening, fencing, hitting a baseball, etc., in which case the gloves may be marked so they stand out better from the background for easier processing by the processor 220. The camera 211 can also be a motion sensing camera, e.g., Microsoft Kinect, or a 3D scanner capable of resolving the expert's hands in 3D space, which can facilitate generating a 3D representation of the expert's hands. The camera 211 can also include one or more video recording devices at different positions oriented towards the expert in order to record 3D spatial information on the expert's hands from multiple perspectives. Furthermore, the camera 211 may record video at variable frame rates, such as 60 frames per second (fps) to ensure video can be displayed to a user in real time. For recording fast motion, or to facilitate slow-motion playback, the camera 211 may record the video at a higher frame rate (e.g., 90 fps, 100 fps, 110 fps, 120 fps, etc.). And the camera 211 may record the video at lower frame rates (e.g., 30 fps) if the expert's hand is stopped or moving slowly to conserve memory and power.

Once the camera 211 finishes the recording, the recorded data may be initially stored on a local storage medium, e.g., a hard drive or other memory, coupled to the camera 211 to ensure the video file is saved. For subsequent processing, the recorded data can be transferred to the processor 220 via a data transmission component 212. Once the transfer of the recorded data to the processor 220 is verified, the recorded data on the local storage medium may be deleted. The data transmission component 212 can be any type of data transfer device including an antenna for a wireless connection, such as Wi-Fi or Bluetooth, or a port for a wired connection, such as an Ethernet cable. Furthermore, data may be transferred to a processor 220, e.g., a computer or a server, connected to the motion capture system 210 via the same local network or a physical connection. Once the recorded data is transferred to a local computer or server, the recorded data may then be uploaded to an offsite computer or server for further processing. For data transfer systems with sufficient bandwidth, the recorded data may also be transferred to the processor 220 in real time.

The motion capture system 210 can also include secondary recording devices to augment the video recordings collected by the camera 211. For example, if the expert is playing an instrument, a microphone 213 or MIDI interface 214 can be included to record the music being played along with the recording. The microphone 213 can also be used to record verbal instructions to support the recordings, thus providing users with more information to help learn a new skill. In another example, a location tracking device, e.g., a GPS receiver, can be used to monitor the location of an expert within a mapped environment while performing a task to provide users the ability to monitor their location for safety zones, such as in a factory. Other secondary devices may include any electrical or mechanical device for a particular skill including a temperature sensor, a voltmeter, a pressure sensor, a force meter, or an accelerometer operably coupled to the motion capture system 210. Secondary devices may also be used in a synchronous manner with the camera 211, e.g., recorded music is synced to a video, using any methods known for synchronous recording of multiple parallel data streams, such as GPS triggering to an external clock.

### Computing Systems for Processing

The processor 220 can include one or more computers or servers coupled to one another via a network or a physical connection. The computers or servers do not need to be located in a single location. For example, the processor 220 may include a computer on a network connected to the motion capture system 210, a computer on a network connected to the XR system 230, and a remote server, which are connected to one another over the Internet. To facilitate communication for each computer or server in the processor 220, software applications can be utilized that incorporate an application programming interface (API) developed for the XR learning system 200. The software applications may further be tailored for administrators managing the XR learning system 200, experts recording content, or users playing content to control varying levels of control over the XR learning system 200, e.g., users may only be allowed to request recordings and experts can upload recordings or manage existing recordings. To support a database of content, the processor 220 may also include a storage server to store recordings from the motion capture system 210, representations of the expert's hands based on these recordings, and any 3D models generated from the representations.

### AR System

A more detailed illustration of the XR system 230 is shown in FIG. 2C. The XR learning system 200 can be used with any type of XR device 231, including the Microsoft Hololens, Google Glass, or a custom-designed XR headset. The XR device 231 can also include a camera and an accelerometer to calibrate the XR device 231 to the user's hands, fiducial markers (e.g., scan registration marks as in FIG. 1), or any instrument(s) used to perform the task to track the location and orientation of the user and user's hand. The XR device 231 may further include an onboard processor, which may be a CPU or a GPU, to control the XR device 231 and to assist with rendering processes when displaying the expert's hands to the user.

The XR device 231 can exchange data, e.g., video of the user's hands for calibration with the 3D model of the expert's hands or a 3D model of the expert's hands performing a task, with the processor 220. To facilitate data transmission, the XR system 230 can also include a data transmission component 232, which can be any type of data transfer device including an antenna for wireless connection, such as Wi-Fi or Bluetooth, or a port for a wired connection, such as an Ethernet cable. Data may be transferred to a processor 220, e.g., a computer or a server, connected to the motion capture system 210 via the same local network or a physical connection prior to a second transfer to a another computer or server located offsite. For data transfer systems with sufficient bandwidth, the rendered 3D models of the expert's hands may also be transferred to the XR system 230 in real time for display.

The XR system 230 can also include secondary devices to augment expert lessons to improve user experience. For example, a speaker 233 can be included to play music recorded by an expert while the user follows along with the expert's hands when playing an instrument. The speaker 233 can also be used to provide verbal instructions to the user while performing the task. The XR system 230 may synchronize the music or instructions to the motion of the 3D model of the expert's hand(s). If the expert plays a particular chord on a guitar or piano, the XR system 230 may show the corresponding motion of the expert's hand(s) and play the corresponding sound over the speaker 233. Likewise, if the expert tightens a bolt with a wrench, the XR system may play verbal instructions to tighten the bolt with the wrench.

Synchronization of audio and visual renderings may work in several ways. For instance, the XR system may generate sound based on a MIDI signal recorded with the camera footage, with alignment measured using timestamps in the MIDI signal and camera footage. Alternatively, a classifier, such as a neural network or support vector machine, may detect sound based on the position of the expert's extremities, e.g., if the expert's finger hits a piano key, plucks a guitar string, etc., in the 3D model representation. The classifier may also operate on audio data collected with the imagery. In this case, the audio data is preprocessed (e.g., Fourier transformed, high/low pass filtered, noise reduction etc.), and the classifier correlates sounds with hand/finger movements based on both visual and audio data. When using the classifier, whether on video and audio data or just video data, recorded content can be re-synchronized many times as the classifier becomes better trained.

Other secondary devices may include any electrical or mechanical device for a particular skill including a temperature sensor, a voltmeter, a pressure sensor, a force meter, or an accelerometer operably coupled to the XR system 230. Data recorded by secondary devices in the motion capture system 210 and data measured by secondary devices in the XR system 230 may further be displayed on the XR device 231 to provide the user additional information to assist with learning a new skill.

### Summary of Data Flow Pathways

FIG. 2D illustrates the flow of data in the XR learning system 200. It shows the various types of data sent and received by the motion capture system 210, the processor 220, and the XR system 230 as well as modules or programs executed by the processor 220 and/or associated devices. A hand position estimator 242 executed by the processor 220 estimates the position of the expert's hand as well as the 3D positions of the joints and bones in the expert's hand from video data acquired by the motion capture system 210 (FIG. 2B). The hand position estimator 242 can be implemented as a more complex set of detectors and classifiers based on machine learning. One approach is to detect the hands in the 2D picture by with an artificial neural network, finding bounding boxes for the hands in the image. Next, the hand position estimator 242 searches for joint approximations for the detected hand(s) using a more complex deep learning network (long-term short memory, or LTSM). When the hand position estimator 242 has estimated the joints, it uses one more deep learning network to estimate 3D model of the hand. Imagery from additional cameras, including one or more depth cameras (RGB-D), may make the estimation more valid.

A format converter unit 244 executed by the processor 220 converts the output of the hand position estimator 242 into a format suitable for use by a lesson creator 246 executed by the processor 220. It converts the 3D joint positions from the hand position estimator into Biovision Hierarchy (BVH) motion capture animation, which entails joints hierarchy and position for every joint for every frame. BVH is an open format for motion capture animations created by Biovision. Other formats are also possible.

The lesson creator 246 uses the formatted data from the format converter unit 244 to generate a lesson that includes XR rendering instructions for the model of the expert's hand (as well as instructions about playing music or providing other auxiliary cues) for teaching the student how to perform a manual task. The lesson creator 246 can be considered to perform two functions: (1) automated lesson creation, which lets the expert easily record a new lesson with automatic detection of tempo, suggestions for dividing lessons for parts, and noise and error removal; and (2) manual lesson creation, which allows the expert (or any other user) to assembly the lesson correctly, extend the lesson with additional sounds, parts, explanations, voice overs, and record more attempts. The lessons can be optimized for storage, distribution and rendering.

Once created, the lesson can be stored in the cloud and shared with any registered client. In FIG. 2D, this cloud-based storage is represented as a memory or database 248 coupled to the processor 220 stores the lesson for retrieval by the XR system 230 (FIG. 2C). The student selects the lesson using a lesson manager 250, which may be accessible via the XR system 230. In response to the user's selection, the XR system 230 renders the model of the expert's hand (252 in FIG. 2D) overlaid on the user's hand as described above and below.

### AR Learning System Methodology

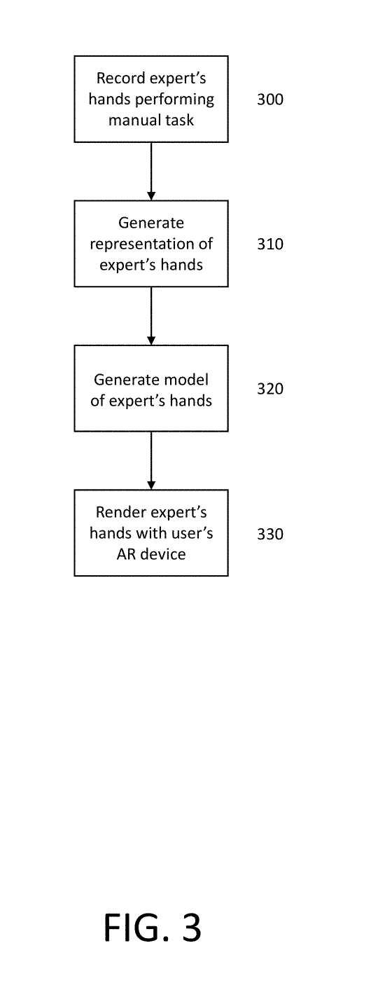

As described above, the XR learning system 200 includes subsystems that enable teaching a user a new skill with hands-on visual guidance using a combination of recordings from an expert performing a task and an XR system 230 that displays the expert's hands overlaid with the user's hands while performing the same task. As shown in FIG. 3, the method of teaching a user a new skill using the XR learning system 200 in this manner can be comprised of the following steps: (1) recording video imagery of one or both of the expert's hands while the expert is performing a task 300, (2) generating a representation of the expert's hands based on analysis of the recording 310, (3) generating a model of the expert's hands based on the representation 320, and (4) rendering the model of the expert's hands using the user's XR device 330. A further description of each step is provided below.

### Recording the Expert's Hands

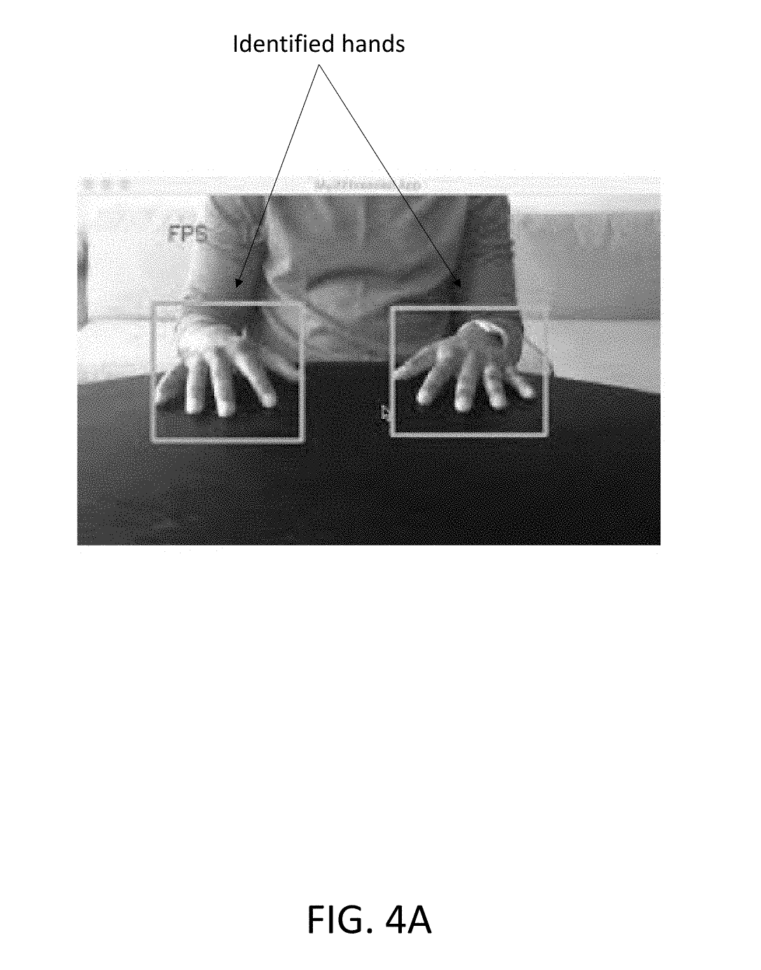

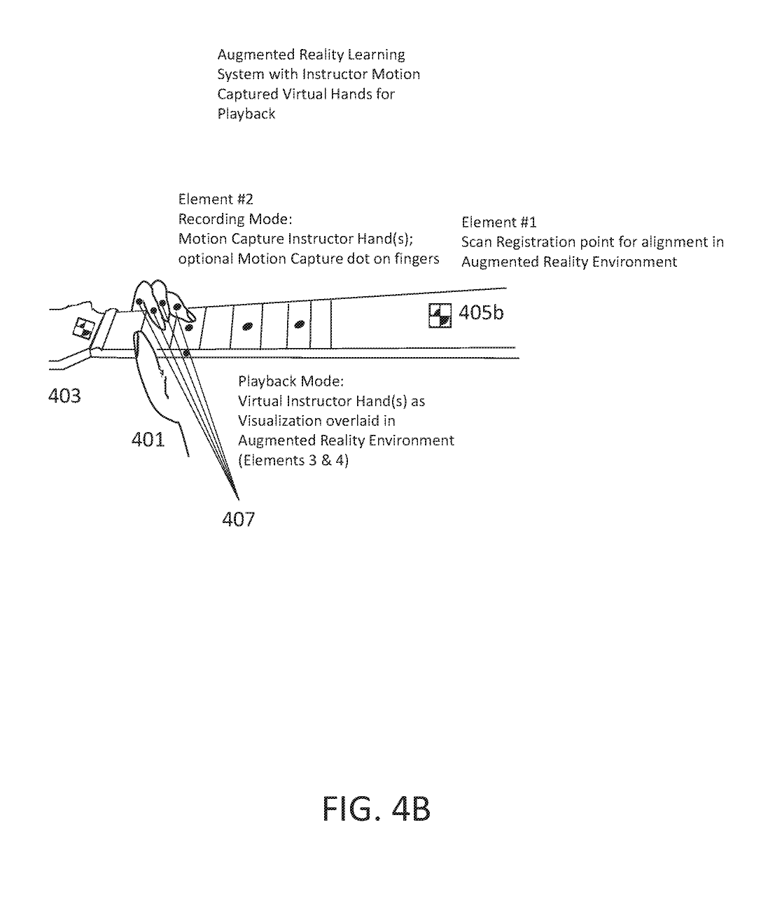

As described above, the XR learning system 200 includes a motion capture system 210 to record the expert's hand(s) performing a task. The motion capture system 210 can include a camera 211 positioned and oriented such that its field of view overlaps with the expert's hand(s) and the instruments used to perform the task. In order to identify and track the expert's hand(s) more accurately, the motion capture system 210 can also record a series of calibration images. The calibrations images can include images of the expert's hand(s) positioned and oriented in one or more known configurations relative to the camera 211, e.g., a top down view of the expert's hands spread out, as shown in FIG. 4A, or any instruments used to perform the task, e.g., a front side view of a guitar showing the strings. If the imagery includes an image of an alignment tag or other fiducial mark, the alignment tag can be used to infer the camera's location, the item's position, and the position of the center of the 3D space. Absolute camera position can be estimated by from the camera stream and recognizing objects and space.

Calibration images may also include a combination of the expert's hand(s) and the instrument where the instrument itself provides a reference for calibrating the expert's hand(s), e.g., an expert's hand placed on the front side of a guitar. The calibration images can also calibrate for variations in skin tone, environmental lighting, instrument shape, or instrument size to more accurately track the expert's hands. Furthermore, the calibration images can also be used to define the relative size and shape of the expert's hand(s), especially with respect to any instruments that may be used to perform the task.

Accuracy can be further improved through use of scan registration points or fiducial markers 405a and 405b (collectively, fiducial markers 405) placed on the expert's hand 401 (e.g., on a glove, temporary tattoo, or sticker) or the instruments (here, a guitar 403) related to the task as shown in FIG. 4B. The fiducial markers 405 may be an easily identifiable pattern, such as a brightly colored dot, a black and white checker box, or a QR code pattern, that contrasts with other objects in the field of view of the motion capture system 210 and the XR system 230. Multiple fiducial markers 405 can be used to provide greater fidelity to identify objects with multiple degrees of freedom, e.g., a marker or dot 407 can be placed on each phalange of the expert's fingers, as shown in FIG. 4B. The fiducial markers may be drawn, printed, incorporated into sleeve, e.g., a glove or a sleeve for an instrument, or any other means of placing a fiducial marker on a hand or an instrument.

The motion capture system 210 can also be optimized to record the motion of the expert's hands with sufficient quality for identification in subsequent processing steps while reducing or minimizing image resolution and frame rate to reduce processing time and data transfer time. As described above, the motion capture system 210 can be configured to record at variable frame rates. For example, a higher frame rate may be preferable for tasks that involve rapid finger and hand motion in order to reduce motion blur in each recorded frame. However, a higher frame rate can also lead to a larger file size, resulting in longer processing times and data transfer times. To determine an optimal frame rate, the motion capture system 210 can also be used to record a series of calibration images while the expert is performing the task. The calibration images can then be analyzed to determine whether the expert's hands or the instrument can be identified with sufficient certainty, e.g., motion blur is minimized or reduced to an acceptable level. This process can be repeated for several frame rates until a desired frame rate is determined that satisfies a certainty threshold. The image resolution can be optimized in a similar manner.

To more quickly calibrate the motion capture system 210, the analysis of calibration images may be performed locally on a computer, e.g., processor 220, networked or physically connected to the motion capture system 210. However, if data transfer rates are sufficient, the analysis could instead be performed offsite on a remote computer or server and relayed back to the motion capture system 210.

### Generating a Representation of an Expert's Hands

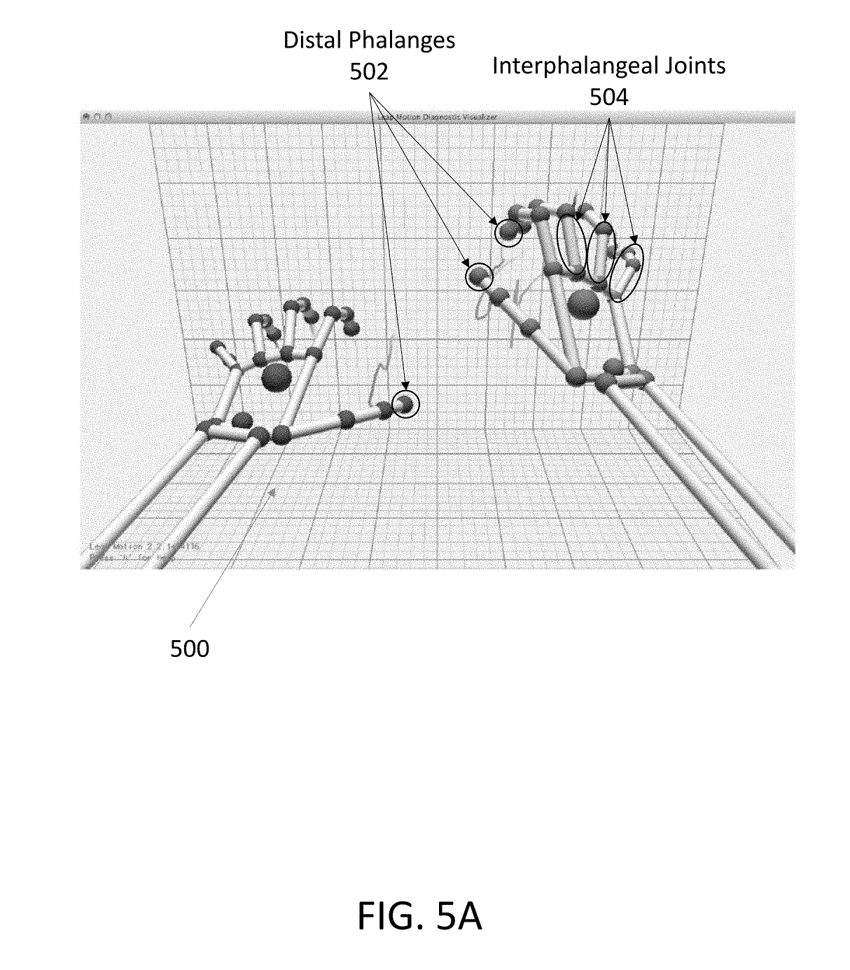

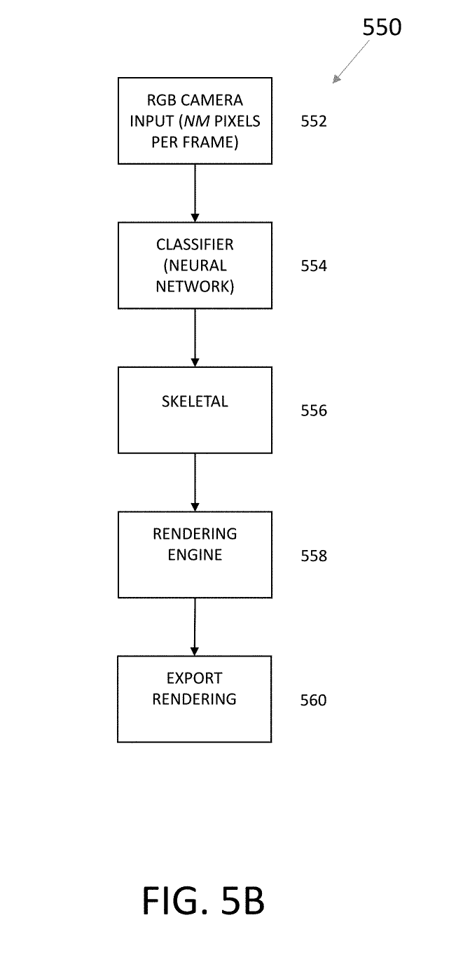

Once the XR learning system 200 records the expert's hands performing a task, it can generate a representation 500 of the expert's hands based on the recording. The representation may include information or estimates about the bone-by-bone locations and orientations of the expert's hands. This representation 500 can be rendered to show distal phalanges 502 and inter-phalangeal joints 504 within each hand as shown in FIG. 5A. As the expert's hands moves, the representation tracks the translational and rotational movement of each bone in a 3D space as a function of time. The representation of the expert's hands thus serves as the foundation to generate a model of the expert's hands to be displayed to the user.

The process of generating a representation from a recording may be accomplished using any one of several methods, including silhouette extraction with blob statistics or a point distribution model, probabilistic image measurements with model fitting, and deep learning networks (DLN). The optimal method for rapid and accurate analysis can further vary depending on the type of recording data captures by the motion capture system 210, e.g., 2D images from a single camera, 2D images from different perspectives captured by multiple cameras, 3D scanning data, and so on.

One method is the use of a convolutional pose machine (CPM), which is a type of DLN, to generate the bone-by-bone representation of the expert's hands. A CPM is a series of convolutional neural networks, each with multiple layers and nodes, that provide iterative refinement of a prediction, e.g., the position of phalanges on a finger are progressively determined by iteratively using output predictions from a prior network as input constraints for a subsequent network until the position of the phalanges are predicted within a desired certainty.

In order to use the CPM to extract the representation of an expert performing a task, the CPM is trained to recognize the expert's hands. This can be accomplished by generating labelled training data where the representation of the expert's hands is actively measured and tracked by a secondary apparatus, which is then correlated to recordings collected by the motion capture system 210. For example, an expert may wear a pair of gloves with a set of positional sensors that can track the position of each bone in the expert's hands while performing a task. The training data can be used to calibrate the CPM until it correctly predicts the measured representation. To ensure the CPM is robust to variations in recordings, labelled training data may be generated for artificially imposed variations, e.g., using different colored gloves, choosing experts with different sized hands, altering lighting conditions during recording by the motion capture system 210, and so on. Labelled training data can also be accumulated over time, particularly if a secondary apparatus is distributed to specific experts who actively upload content to the XR learning system 200. Furthermore, different CPMs may be trained for different tasks to improve the accuracy of tracking an expert's hands according to each task.

Once the representation of the expert's hands is generated, it may be stored for later retrieval on a storage device coupled to the processor 220, e.g., a storage server or database. Storing the representation in addition to the recording reduces the time necessary to generate and render a model of the expert's hands. This can help to more rapidly provide a user content.

As shown in FIG. 5B, an image recorded at a particular resolution, corresponding to a particular frame from a series of images in a video, can be used as input to the CPM, which outputs the 3D translational and rotational data of each bone in the expert's hands. In order to improve convergence and more accurately identify the expert's hands, the input images can be adjusted prior to its application to a CPM by changing the contrast, increasing the image sharpness, reducing noise, and so on.

More specifically, FIG. 5B shows a process 550 for hand position estimation, format conversion, and rendering using a processor-implemented converter that creates a 3D hand model animation from raw video footage. It receives an RGB camera stream with NM pixels per frame as input (552). It implements a classifier, such as a neural network, that detects the joints of the body parts visible in the image (554). The converter creates a skeletal model of the body parts, e.g., of the just the hand or even the whole human body (556). At this stage, the converter may have detailed 3D position of whole human skeleton, that is, six degrees of freedom (DOF) for every skeletal joint on every frame of the video input. The converter uses this skeletal model to render the 3D hand (or human body for the general case) applying model, texture (skin, color), details, lighting, etc. (558). It then exports the rendering in a format suitable for display via an XR device, e.g., as .fbx (3D model for XR general graphics engine), unityasset (3D model optimized for Unity-type engines), or .bvh for the simplest data stream.

The converter can be optimized, if desired, by applying information from past frames to improve detection and classification time and correctness. It can be implemented by recording the expert's hand, then sending the recording to the cloud for detection and recognition. It can also be implemented such that it estimates 3D position of the expert's body or body parts in real-time based on a live camera stream. Motion prediction can be improved using a larger library of hand movement by interpolating estimations using animations from the library. A larger library is especially useful for input data that is corrupt or of low quality.

Rendering can be optimized by rendering some features on the server and others on the XR device to reduce demand's on the XR device's potentially limited GPU power. Prerendering in the cloud (server) may improve 3D graphics quality. Similarly, compressing data for transfer from the server to the XR device can reduce latency and improve rendering performance.

### Generating a Model of the Expert's Hands

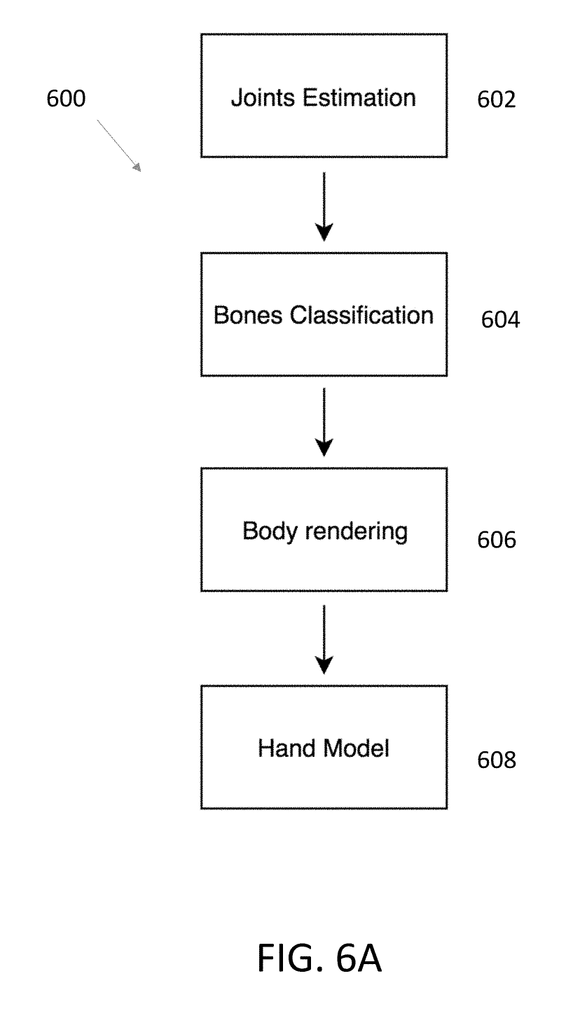

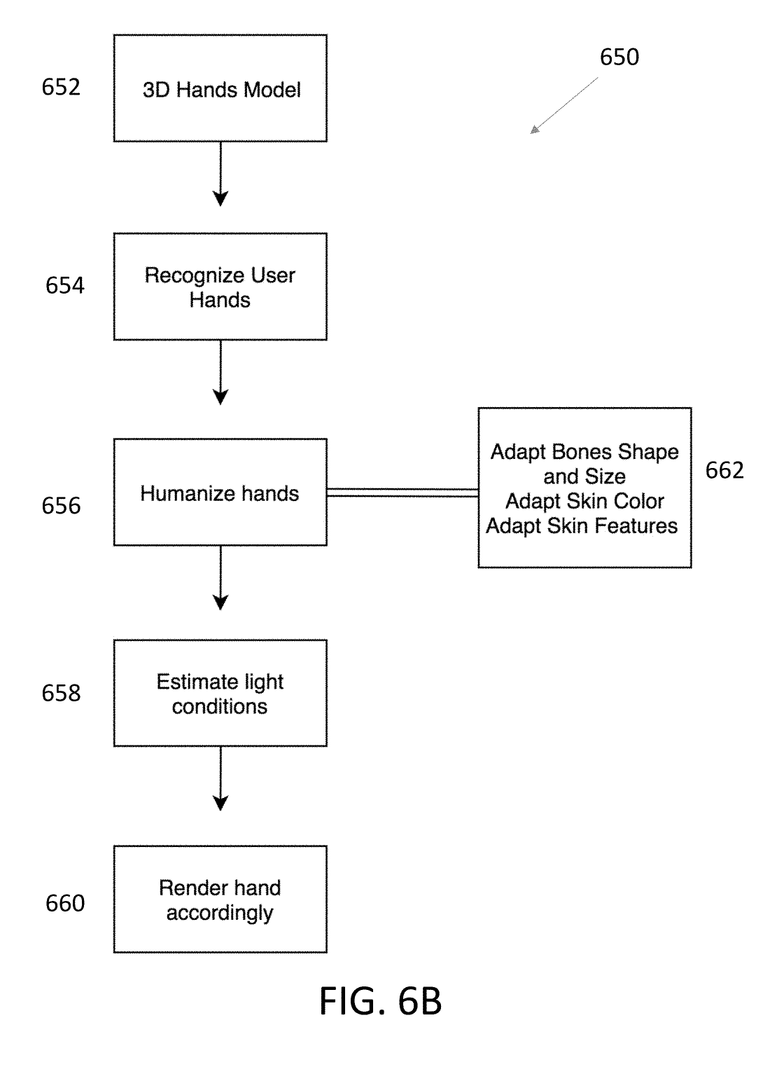

Based on the generated representation of the expert's hands, the processor 220 generates a model of the expert's hands for display on the user's XR device 231. One process 600, shown in FIG. 6A, is to use a standard template for a hand model as a starting point, e.g., a 3D model that includes the palm, wrist, and all phalanges for each finger. The template hand model can also include a predefined rig coupled to the model to facilitate animation of the hand model. The process 600 include estimating the locations of the joints in the expert's hand (and wrist and other body parts) (602), classifying the bones in the expert's hand (604), rendering the expert's hand and/or other body parts (606), and generating the hand model (608). The hand model can then be adjusted in size and shape to match the generated representation of the expert's hands. Once matched, the adjusted hand model can be coupled to the representation and thus animated according to the representation of the expert's hands performing a task. The appearance of the hand model can be modified according to user preference. For example, a photorealistic texture of a hand can be applied to the hand model. Artificial lighting can also be applied to light the hand model in order to provide a user more detail and depth when rendered on the user's XR device 231.

In many instances, the expert's hands may differ in size, shape, and location from the user's hands. Furthermore, the expert's instruments or tools may also differ in size and shape from the user's instruments or tools. The processor can estimate the sizes of the expert's hands and tools based on the average distances between joints in the expert's hand and the positions of the expert's hand, tools, and other objects in the imagery.

To display the expert's hands on the user's XR device 231 in a manner that would enable the user to follow the expert, the generated model can be adapted to the user. One approach is to rescale the generated representation of the expert's hands to better match the user's hands without compromising the expert's technique for each frame in the recording as shown in FIG. 6B. After the generated representation is modified, a model can then be generated according to the methods described above.

FIG. 6B shows another process 650 implemented by a processor on the XR device 231 or in the cloud for rescaling and reshaping the generated representation to match the user's hands. The process 650 starts with the 3D hand model 652 of the expert's hand. It recognizes the user's hand (654) and uses it to humanize the 3D hand model (656), e.g., by adapting the shapes and sizes of the bones, the skin color, the skin features, etc. (662). It estimates the light conditions (658) from a photosensor or camera image captured by a camera on the XR device. Then it renders the hand accordingly (660).

In order to ensure proper technique is conveyed to the user, the representation may be further modified such that the relative motion of each phalange is adapted to the user's hands, e.g., an expert's hand fully wraps around an American football and a user's hand only partially wraps around the football. For example, physical modeling can be used to modify the configuration of the user's hands such that the outcome of specific steps performed in a task are similar to the expert. A comparison between the user and the expert may be further augmented by the use of secondary devices, as described above. In another example, a set of representations from different experts performing the same task may sufficiently encompass user variability such that a particular representation can be selected that best matches the user's hands.

To adapt the generated representation to the user, a single or a set of calibration images can be recorded by a camera in the user's XR device 231 or a separate camera. The calibration images can include images of the user's hands positioned and oriented in a known configuration relative to the XR device 231, e.g., a top down view of the expert's hands spread out and placed onto the front side of a guitar. From these calibration images, a representation of the user's hand can be processed using a CPM. Once the representation of the user's hands is generated, a representation of an expert's hand can be modified according to the representation of the user's hands according to the methods describe above. A model of the expert's hands can then be generated accordingly. Fiducial markers can also be used to more accurately identify the user's hands.

Once a model of the expert's hands is generated and possibly modified to adapt to the user's hands, the animation of the model can be stored on a storage device coupled to the processor 220, e.g., a storage server. This can help a user to rapidly retrieve content, particularly if the user wants to replay a recording.

### Rendering the Model of the Expert's Hands

The XR system 230 renders the model such that the user can observe and follow the expert's hands as the user performs a task. The process of rendering and displaying the model of the expert's hands can be achieved using a combination of a processor, e.g., a CPU or GPU, which receives the generated model of the expert's hands and executes rendering processes in tandem with the XR device's display. The user can control when the rendering begins by sending a request via the XR device 231 or a remote computer coupled to the XR device 231 to transfer the animated model of the expert's hands. Once a request is received, the model may be generated and modified according to the methods described above, or a previous model may simply be transferred to the XR system 230.

In order to display the expert's hands correctly, the model of the expert's hands is aligned to the user using references that can be viewed by the XR system 230, such as the user's hands, a fiducial marker, or an instrument used to perform the task. For example, the XR system 230 can record a calibration image that includes a reference, e.g., a fiducial marker on a piano or an existing pipe assembly in a building. Once a reference is identified, the model of the expert's hands can be displayed in a proper position and orientation in relation to the stationary reference, e.g., display expert's hands slightly above the piano keys of a stationary piano. If the XR system 230 includes an accelerometer and a location tracking device, the XR system 230 can monitor the location and orientation of the user relative to the reference and adjust the rendering of the expert's hands accordingly as the user moves.

In another example, the XR system 230 can track the location of an instrument using images collected by the XR system 230 in real time. The XR system 230 determines the position and orientation of the instrument based on the recorded images. This approach may be useful in cases where no reference is available and an instrument is likely to be within the field of view of the user, e.g., a user is playing a guitar.

The rendering of the XR hand can be modified based on user preference—it can be rendered as a robot hand, human hand, animal paw, etc., and can have any color and any shape. One approach is to mimic the user's hand as closely as possible and guide the user with movement of the rendering just a moment before the user's hand is supposed to move. Another approach is to create a rendered glove-like experience superimposed on the user's hand. The transparency of the rendering is also question of a preference. It can be changed based on user's preferences, lighting conditions, etc. and recalibrated to achieve the desired results.

In addition to displaying the expert's hands, the XR system 230 can also display secondary information to help the user perform the task. For example, the XR system 230 can highlight particular areas of an instrument based on imagery recorded by the XR system 230, e.g., highlighting guitar chords on the user's guitar as shown in FIG. 4B. Data measured by secondary devices, such as the temperature of an object being welded or the force used to hit a nail with a hammer, can be displayed to the user and compared to corresponding data recorded by an expert. The XR system 230 can also store information to help a user track their progression through a task, e.g., highlights several fasteners to be tightened on a mechanical assembly with a particular color and change the color of each fastener once tightened.

The XR system 230 can also render the model of the expert's hands at variable speeds. For example, the XR system 230 can render the model of the expert's hands in real time. In another example, the expert's hands may be rendered at a slower speed to help the user track the hand and finger motion of an expert as they perform a complicated task, e.g., playing multiple guitar chords in quick succession. In cases where a model is rendered at lower speeds, the motion of the rendered model may not appear smooth to the user if the recorded frame rate was not sufficiently high, e.g., greater than 60 frames per second. To provide a smoother rendering of the expert's hands, interpolation can be used to add frames to a representation of the expert's hands based on the rate of motion of the expert's hands and the time step between each frame.

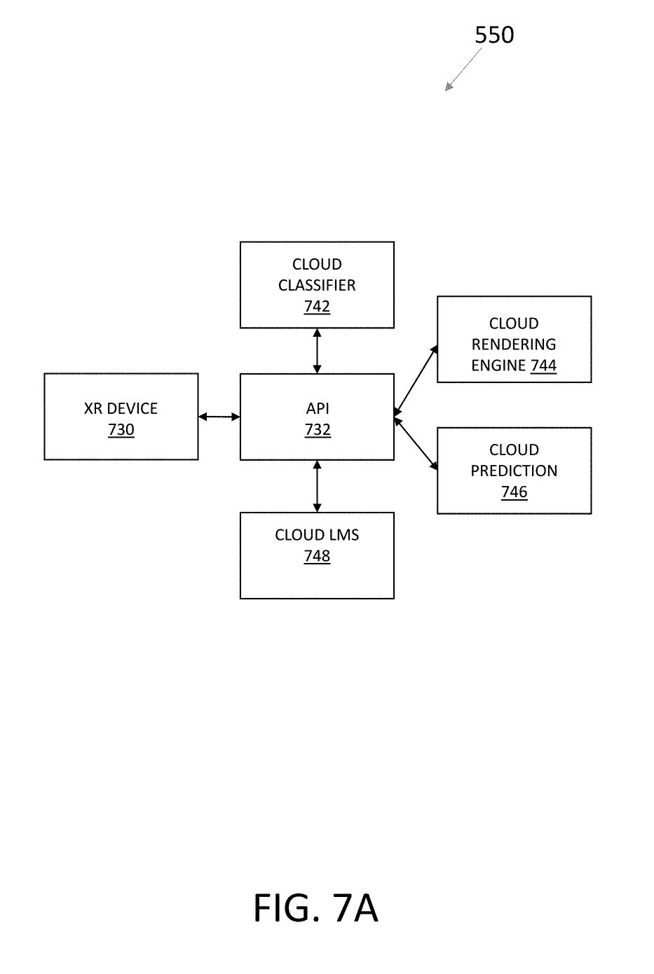

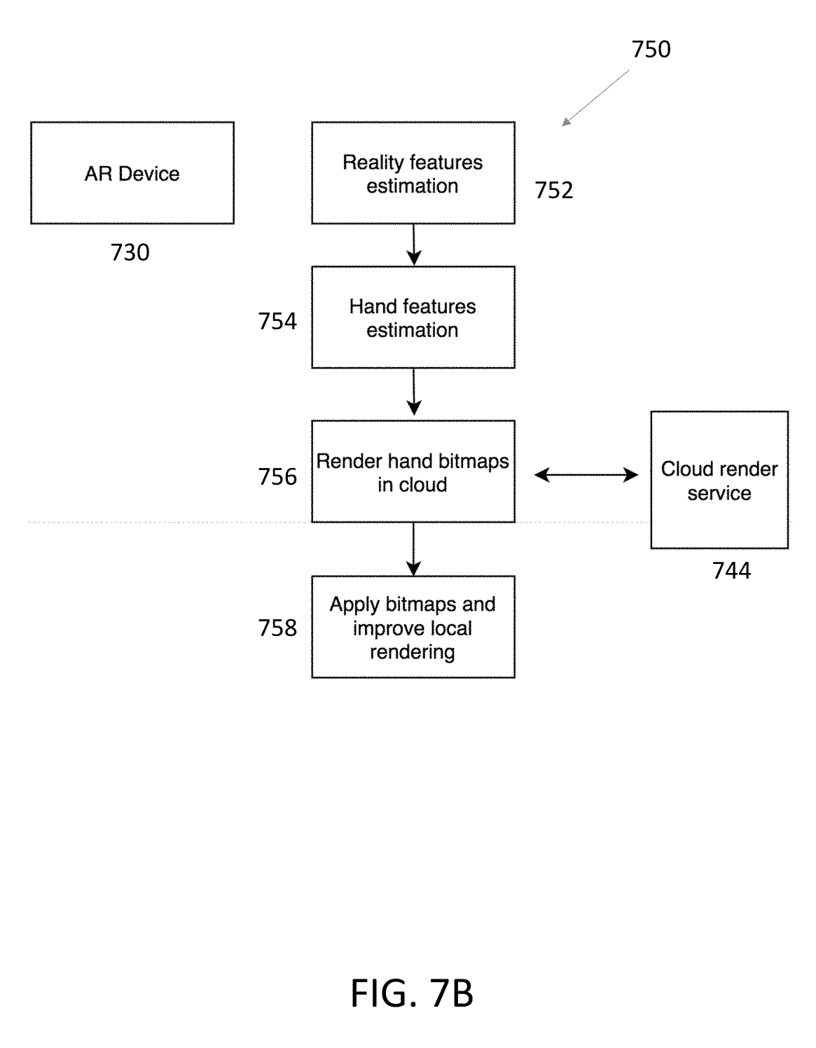

Rendering the model of the expert's hands in real time at high frame rates can also involve significant computational processing. In cases where the onboard processor on the XR system 230 is not sufficient to render the model under such conditions, rendering processes can also be distributed between the onboard processor on an XR system 230 and a remote computer, server, or smartphone. As shown in FIGS. 7A and 7B, if rendering processes are distributed between multiple devices, additional methods can be used to properly synchronize the devices to ensure rendering of the expert's hands is not disrupted by any latency between the XR device 231 and a remote computer or server.

FIG. 7A shows a general system architecture 700 for distributed rendering. An application programming interface (API), hosted by a server, provides a set of definitions of existing services for accessing data, uploading, downloading, removing, etc. data through the system 700. A cloud classifier 742 detects the expert's hand. A cloud rendering engine 744 renders the expert's hand or other body part. A cloud classifier detects the expert's hand. And a cloud learning management system (LMS) 748, which can be implemented as a website with user login, tracks skill development, e.g., with a social media profile etc. (The cloud classifier 742, cloud rendering engine 744, and cloud LMS 748 can be implemented with one or more networked computers as readily understood by those of skill in the art.)

An XR device displays the rendered hand to the user according to the lesson from the cloud LMS 748 using the process 750 shown in FIG. 7B. This process involves estimating features of reality (e.g., the position of the user's hand and other objects) (752), estimating features of the user's hand (754), rendering bitmaps of the expert's hand (756) with the cloud rendering engine 744, and applying the bitmaps to the local rendering of the expert's hand by the XR device. Rendering bitmaps of the expert's hand with the cloud rendering engine 744 reduces the computational load on the XR device, reducing latency and improving the user's experience.

### Conclusion

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the U.S. Patent Office Manual of Patent Examining Procedures, Section 2111.03.

1. A method of teaching a user to perform a manual task with an extended reality (XR) device, the method comprising:
recording a series of images of an expert's hand with a camera while the expert's hand is performing the manual task;
generating, with a deep-learning network (DLN) implemented by a processor operably coupled to the camera, a representation of the expert's hand based on the series of images of the expert's hand;
generating a model of the expert's hand based on the representation of the expert's hand; and
rendering, with the XR device, the model of the expert's hand overlaid on a user's hand while the user is performing the manual task so as to guide the user in performing the manual task.

2. The method of claim 1, wherein recording the series of images of the expert's hand comprises imaging an instrument manipulated by the expert's hand while performing the manual task.

3. The method of claim 2, wherein the instrument comprises a musical instrument and the manual task comprises playing the musical instrument.

4. The method of claim 3, wherein rendering the model of the expert's hand comprises playing an audio recording of the musical instrument played by the expert synchronized with the rendering the model of the expert's hand playing the musical instrument.

5. The method of claim 3, further comprising:
recording music played by the expert on the musical instrument while recording the series of images of the expert's hand playing the musical instrument.

6. The method of claim 2, wherein the instrument comprises a hand tool and the manual task comprises installing at least one of a heating, ventilation, and air conditioning (HVAC) system component, a piece of plumbing, or a piece of electrical equipment.

7. The method of claim 2, wherein the instrument comprises a piece of sporting equipment and the manual task comprises playing a sport.

8. The method of claim 1, wherein recording the series of images of the expert's hand comprises acquiring at least one calibration image of the expert's hand.

9. The method of claim 1, wherein recording the series of images of the expert's hand comprises acquiring at least one image of a fiducial marker associated with the manual task.

10. The method of claim 1, wherein:
recording the series of images of the expert's hand comprises acquiring the series of images at a first frame rate; and
rendering the model of the expert's hand comprises rendering the model of the expert's hand at a second frame rate different than the first frame rate.

11. The method of claim 1, wherein generating the representation of the expert's hand comprises providing the series of images to the DLN in real time.

12. The method of claim 11, wherein generating the model of the expert's hand and rendering the model of the expert's hand is performed in real time.

13. The method of claim 1, wherein generating the representation of the expert's hand comprises outputting a bone-by-bone representation of the expert's hand, the bone-by-bone representation providing distal phalanges and distal inter-phalangeal movement of the expert's hand.

14. The method of claim 1, wherein generating the representation of the expert's hand comprises outputting translational and rotational information of the expert's hand in a space of at least two dimensions.

15. The method of claim 1, wherein generating the model of the expert's hand comprises adapting the model of the expert's hand to the user based on at least one of a size of the user's hand, a shape of the user's hand, or a location of the user's hand.

16. The method of claim 1, wherein rendering the model of the expert's hand comprises distributing rendering processes across a plurality of processors.

17. The method of claim 16, wherein the plurality of processors comprises a first processor operably disposed in a server and a second processor operably disposed in the XR device.

18. The method of claim 1, wherein rendering the model of the expert's hand comprises aligning the model of the expert's hand to at least one of the user's hand, a fiducial mark, or an instrument manipulated by the user while performing the manual task.

19. The method of claim 1, wherein rendering the model of the expert's hand comprises highlighting a feature on an instrument while the user is manipulating the instrument to perform the manual task.

20. The method of claim 1, wherein rendering the model of the expert's hand comprises rendering the model of the expert's hand at a variable speed.

21. A system for teaching a user to perform a manual task, the system comprising:
at least one processor to generate a representation of an expert's hand based on a series of images of the expert's hand performing the manual task with a deep-learning network (DLN) and to generate a model of the expert's hand based on the representation of the expert's hand; and
an extended reality (XR) device, operably coupled to the processor, to render the model of the expert's hand overlaid on the user's hand while the user is performing the manual task so as to guide the user in performing the manual task.

22. The system of claim 21, wherein the manual task comprises playing a musical instrument and wherein the XR device comprises a speaker to play an audio recording of the musical instrument played by the expert synchronized while the XR device renders the model of the expert's hand playing the musical instrument.

23. The system of claim 21, wherein the at least one processor is configured to output a bone-by-bone representation of the expert's hand, the bone-by-bone representation providing distal phalanges and distal inter-phalangeal movement of the expert's hand.

24. The system of claim 21, wherein the at least one processor is configured to output translational and rotational information of the expert's hand in a space of at least two dimensions.

25. The system of claim 21, wherein the at least one processor is configured to adapt the model of the expert's hand to the user based on at least one of a size of the user's hand, a shape of the user's hand, or a location of the user's hand.

26. The system of claim 21, wherein the XR device is configured to render the model of the expert's hand in real time.

27. The system of claim 21, wherein the at least one processor is configured to render a first part of the model of the expert's hand and the XR device is configured to render a second part of the model of the expert's hand.

28. The system of claim 21, wherein the XR device is configured to render the model of the expert's hand at a variable speed.

29. The system of claim 21, wherein the XR device is configured to align the model of the expert's hand to at least one of the user's hand, a fiducial mark, or an instrument manipulated by the user while performing the manual task.

30. The system of claim 21, wherein the XR device is configured to highlight a feature on an instrument while the user is manipulating the instrument to perform the manual task.

31. The system of claim 21, further comprising:
a camera, operably coupled to the at least one processor, to record the series of images of an expert's hand while the expert's hand is performing the manual task.

32. The system of claim 31, wherein the camera is configured to record the series of images of the expert's hand at a first frame rate and the XR device is configured to render the model of the expert's hand at a second frame rate different than the first frame rate.

33. The system of claim 31, wherein the camera is configured to acquire at least one calibration image of the expert's hand.

34. The system of claim 31, wherein the camera is configured to acquire at least one image of a fiducial marker associated with the manual task.

35. The system of claim 31, wherein the camera is configured to record the series of images of the expert's hand and to transfer the series of images to the at least one processor for generating the representation of an expert's hand in real time.

36. The system of claim 31, wherein the manual task comprises playing a musical instrument and further comprising:
a microphone, operably coupled to the at least one processor, to record music played by the expert on the musical instrument while the camera records the series of images of the expert's hand playing the musical instrument.
